(19) United States
(12) Patent Application Publication
(10) Pub. No.: US 2018/0120678 A1
(43) Pub. Date: May 3, 2018

(54) PROJECTION OPTICAL DEVICE, IMAGE PROJECTION APPARATUS, AND ADJUSTER

(71) Applicants: Yasunari MIKUTSU, Tokyo (JP); Satoshi TSUCHIYA, Kanagawa (JP); Takehiro NISHIMORI, Kanagawa (JP); Jun MASHIMO, Tokyo (JP); Tetsuya FUJIOKA, Kanagawa (JP); Hideo KANAI, Kanagawa (JP)

(72) Inventors: Yasunari MIKUTSU, Tokyo (JP); Satoshi TSUCHIYA, Kanagawa (JP); Takehiro NISHIMORI, Kanagawa (JP); Jun MASHIMO, Tokyo (JP); Tetsuya FUJIOKA, Kanagawa (JP); Hideo KANAI, Kanagawa (JP)

(73) Assignee: Ricoh Company, Ltd., Tokyo (JP)

(21) Appl. No.: 15/788,283

(22) Filed: Oct. 19, 2017

(30) Foreign Application Priority Data
Oct. 31, 2016 (JP) 2016-212913

(51) Int. Cl. G03B 21/14; G03B 21/28

(52) U.S. Cl. CPC G03B 21/142; G03B 21/008; G03B 21/28; G03B 21/145

(57) ABSTRACT

A projection optical device includes a projection lens unit, a projection optical element, an optical housing, a holder, and a mover. The projection lens unit holds a projection lens on which a projection image generated by an image generating device is incident. The projection optical element guides the projection image, which has passed through the projection lens, to a projection surface. The optical housing is attached with the image generating device. The holder is attached to the optical housing. The holder holds the projection lens unit and the projection optical element. The mover relatively moves the holder with respect to the optical housing in an incident direction in which the projection image is incident on the projection lens.

### CROSS-REFERENCE TO RELATED APPLICATIONS

This patent application is based on and claims priority pursuant to 35 U.S.C. § 119(a) to Japanese Patent Application No. 2016-212913, filed on Oct. 31, 2016 in the Japan Patent Office, the entire disclosure of which is hereby incorporated by reference herein.

### BACKGROUND

Technical Field

Aspects of the present disclosure relate to a projection optical device, an image projection apparatus, and an adjuster.

Related Art

An image projection apparatus is known that generates a projection image by a digital micro-mirror device (DMD) as an image generating device using light emitted from a light source, transmits the projection image through a set of projection lenses held by a projection lens unit of a projection optical device, and then reflects the projection image by a reflection mirror as a projection optical element to project the reflected projection image onto a projection surface. The projection lens unit and the reflection mirror are held by a holder. The holder is attached to an optical housing to which the DMD is attached.

### SUMMARY

In an aspect of the present disclosure, there is provided a projection optical device that includes a projection lens unit, a projection optical element, an optical housing, a holder, and a mover. The projection lens unit holds a projection lens on which a projection image generated by an image generating device is incident. The projection optical element guides the projection image, which has passed through the projection lens, to a projection surface. The optical housing is attached with the image generating device. The holder is attached to the optical housing. The holder holds the projection lens unit and the projection optical element. The mover relatively moves the holder with respect to the optical housing in an incident direction in which the projection image is incident on the projection lens.

In another aspect of the present disclosure, there is provided an image projection apparatus that includes a light source, the image generating device, and the projection optical device. The image generating device forms a projection image with light from the light source. The projection optical device projects the projection image onto the projection surface.

In still another aspect of the present disclosure, there is provided an adjuster for adjustment of a distance between an image generating device to generate a projection image and a projection lens unit holding a projection lens on which the projection image generated by the image generating device is incident. The adjuster includes a base portion and a plurality of mount portions. The base portion has a through hole through which the projection lens unit passes. The plurality of mount portions support a holder holding the projection lens unit and a projection optical element that guides the projection image, which has passed the projection lens unit and the projection lens, to a projection surface. The plurality of mount portions are disposed at both ends of the base portion in a direction perpendicular to an incident direction in which the projection image is incident on the projection lens. Each of the plurality of mount portions has a contact surface to contact and relatively move the holder in the incident direction with respect to an optical housing, to which the image generating device is attached, to adjust the distance between the image generating device and the projection lens unit.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a perspective view of a projector and a projection surface according to an embodiment of the present disclosure;

FIG. 2A is a perspective view of the interior of the projector seen from arrow A in FIG. 1;

FIG. 2B is a perspective view of the interior of the projector seen from arrow B in FIG. 1;

FIG. 3 is a perspective view of an optical engine according to an embodiment of the present disclosure;

FIG. 4 is an illustration of an optical path of light in a lighting device;

FIG. 5 is an illustration of an example pf an internal configuration of a projection optical device;

FIG. 6 is a schematic view of a comparative example of back focus adjustment;

FIG. 7 is a cross-sectional view of the projection optical device, a lighting housing, and a DMD in an embodiment of the present disclosure;

FIG. 8 is a side view of the projection optical device and the lighting housing seen from a direction C of FIG. 7;

FIGS. 9A and 9B are illustrations of an example of a slider used as an adjustment jig in a production process;

FIG. 10 is a cross-sectional view of a part of a variation of the projection optical device; and

FIG. 11 is a side view of the variation seen from a direction F of FIG. 10.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

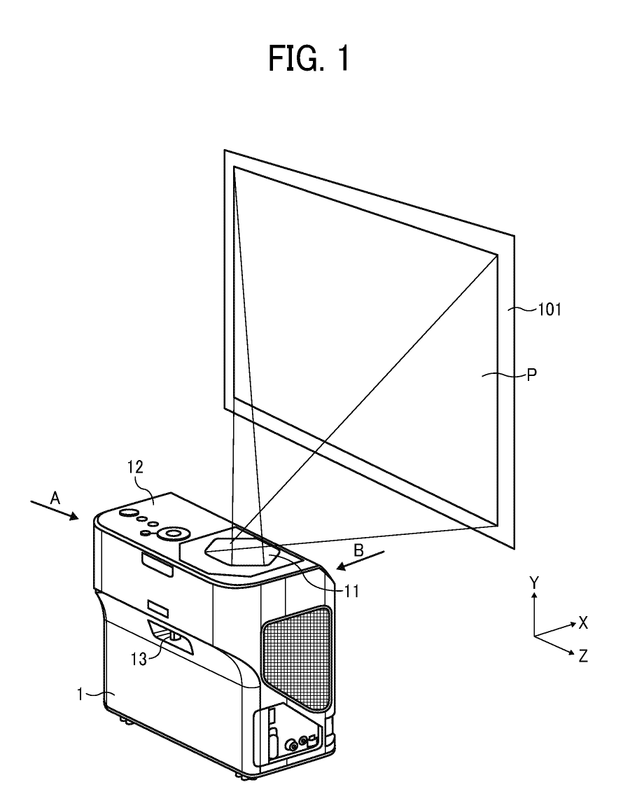

Below, a description is given of a projector as an image projection apparatus according to an embodiment of the present disclosure. FIG. 1 is a perspective view of a projector 1 and a projection surface 101, such as a screen, according to the present embodiment. A short focus type projector is described as an example of the projector 1. In the following description, the normal direction of the projection surface 101 is referred to as X direction, the short axis direction (vertical direction) of the projection surface 101 is referred to as Y direction, and the long axis direction (horizontal direction) of the projection surface 101 is referred to as Z direction.

As illustrated in FIG. 1, a transparent glass 11 from which a projection image P is emitted is provided on an upper surface of the projector 1, and the projection image P emitted from the transparent glass 11 is projected onto the projection surface 101, such as a screen. An operation unit 12 for a user to operate the projector 1 is disposed on the upper surface of the projector 1. A focus lever 13 for focus adjustment is provided on a side surface of the projector 1.

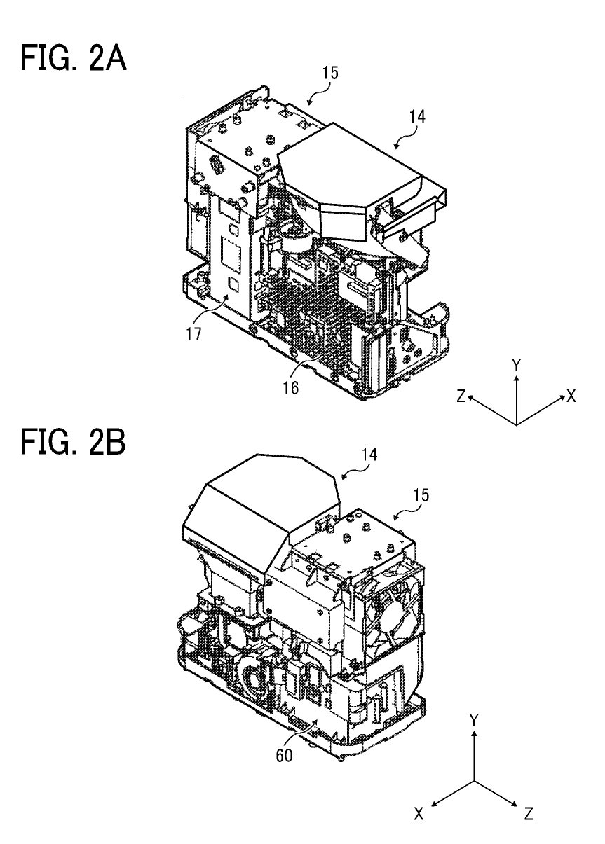

FIG. 2A is a perspective view of the interior of the projector 1 seen from arrow A in FIG. 1. FIG. 2B is a perspective view of the interior of the projector 1 seen from arrow B in FIG. 1. As illustrated in FIGS. 2A and 2B, an optical engine 14 and a power factor correction (PFC) power supply unit 15 are arranged in the projector 1. As illustrated in FIG. 2A, a control board 16 is disposed on the −X side (the side opposite to the projection surface 101 side) of the optical engine 14. Below the PFC power supply unit 15, a ballast power supply unit 17 is disposed to stably supply power to a light source device 60. Further, as illustrated in FIG. 2B, the light source device 60 including, e.g., a high-pressure mercury lamp, a laser, and a light-emitting-diode (LED) light source is disposed below the PFC power supply unit 15.

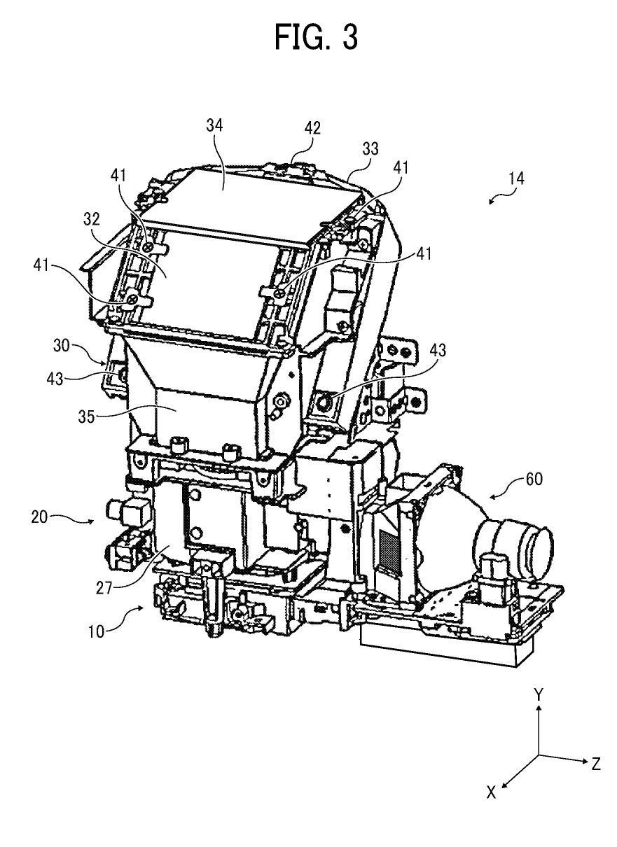

FIG. 3 is a schematic perspective view of the optical engine 14. As illustrated in FIG. 3, the optical engine 14 includes, e.g., the light source device 60, a projection image generating device 10, a lighting device 20, and a projection optical device 30. The light source device 60 is disposed on a side surface of the lighting device 20 and irradiates light in the Z direction. The lighting device 20 guides the light irradiated from the light source device 60 by an illumination optical system to the projection image generating device 10, which is disposed below the lighting device 20. The illumination optical system, which is described later, is disposed in a lighting housing 27. The projection image generating device 10 is attached to a lower portion of the lighting housing 27 and generates a projection image using the light guided by the lighting device 20. The projection optical device 30 is attached to an upper portion of the lighting housing 27. The projection optical device 30 includes a projection lens unit 31 (see FIG. 5), a reflection mirror 32 as a projection optical element, a curved mirror 33 as a projection optical element, and a cover glass 34, which are held on a projection housing 35 as a holder. The cover glass 34 prevents dust and the like from entering the projection housing 35. The projection optical device 30 projects the projection image generated by the projection image generating device 10 to the outside of the projector 1.

The reflection mirror 32 and the cover glass 34 are positioned and secured to the projection housing 35 by being pressed against the projection housing 35 by retainers 41 of a flat-spring shape. The curved mirror 33 is pressed against the projection housing 35 at an approximate center of an upper end portion by a curved mirror retainer 42 of a flat-spring shape, and both lower ends of the curved mirror 33 in the Z direction are secured to the projection housing 35 by screws 43.

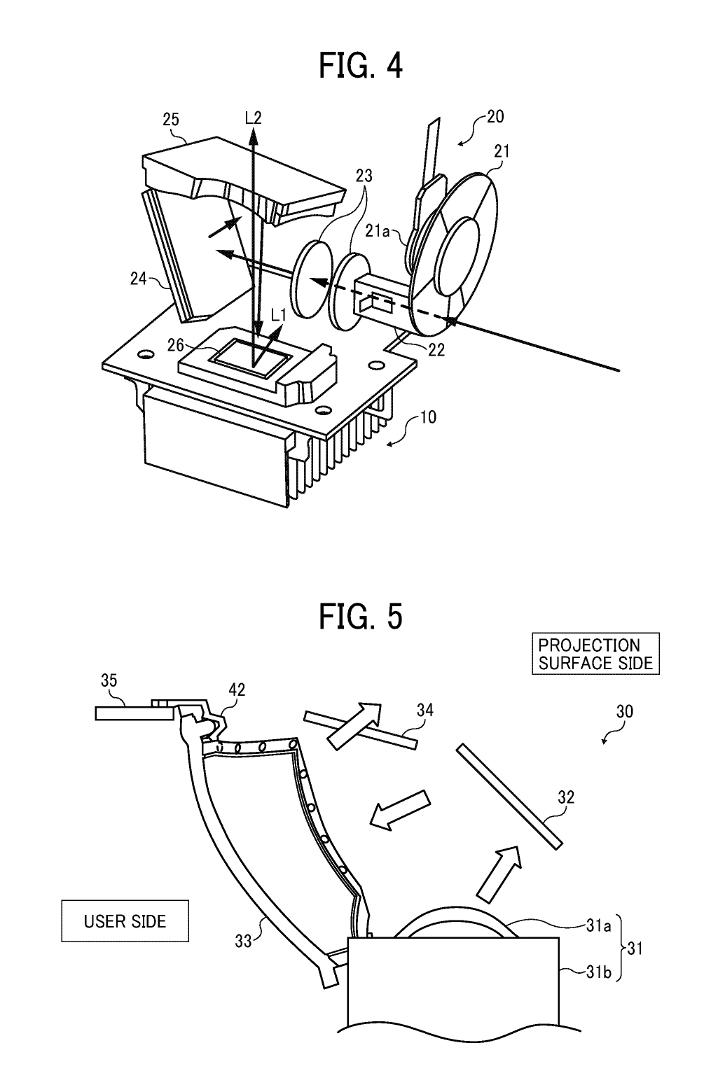

FIG. 4 is an illustration of an optical path of light inside the lighting device 20. The lighting device 20 includes, e.g., a color wheel 21, a light tunnel 22, relay lenses 23, a cylinder mirror 24, and a concave mirror 25 as the illumination optical system. The color wheel 21 has a disk shape and is secured to a motor shaft of a color motor 21a. Filters, such as red (R), green (G), and blue (B) filters, are arranged on the color wheel 21 in a rotation direction of the color wheel 21. White light condensed by a reflector provided in a holder of the light source device 60 reaches a peripheral end portion of the color wheel 21 through an exit window. The white light having reached the peripheral end portion of the color wheel 21 is separated into R, G, B lights in a time-division manner by the rotation of the color wheel 21.

The light separated by the color wheel 21 is incident on the light tunnel 22. The light tunnel 22 has a square tubular shape, and the inner circumferential surface of the light tunnel 22 is a mirror surface. The light incident on the light tunnel 22 is reflected by the inner circumferential surface of the light tunnel 22 plural times to be a uniform surface light source, and is emitted toward relay lenses 23. The relay lenses 23 converge the light while correcting chromatic aberration on the optical axis.

The light leaving the light tunnel 22 passes through the two relay lenses 23, is reflected by the cylinder mirror 24 and the concave mirror 25, and is converged and imaged on an image generation surface of a digital micro-mirror device (DMD) 26. The DMD 26 is an image generation device disposed in the projection image generating device 10.

A plurality of movable micro-mirrors are arranged in a lattice pattern on the image generation surface of the DMD 26. Each micro-mirror can tilt a mirror surface of the micro-mirror at angles around a torsion axis and can have two states of “ON” and “OFF”. When the micro-mirror is “ON”, as indicated by arrow L2 in FIG. 4, the light from the light source is reflected toward the projection lens unit 31. When the micro-mirror is “OFF”, as indicated by arrow L1 in FIG. 4, the light from the light source device 60 is reflected toward an OFF light plate held on a side surface of the lighting housing 27. Therefore, by separately driving each mirror, light projection can be controlled for each pixel of image data, to generate an image.

FIG. 5 is an illustration of an example pf an internal configuration of the projection optical device 30. The projection optical device 30 includes the projection lens unit 31, the reflection mirror 32 which is a plane mirror, the curved mirror 33, and the cover glass 34. The projection lens unit 31 includes, e.g., a plurality of projection lenses 31a and a lens barrel 31b to hold the projection lenses 31a, and images a projection image generated by the DMD 26 on the reflection mirror 32. The reflection mirror 32 and the curved mirror 33 reflect the formed projection image in an enlarged manner and guide the reflected projection image to the projection surface 101 outside the projector 1. The projection image guided to the projection surface 101 passes through the cover glass 34 and is projected onto the projection surface 101.

The so-called back focus, which is the distance between the DMD 26 and the projection lens unit 31, may deviate from a prescribed distance due to a manufacturing error of the lighting housing 27 to which the projection optical device 30 and the projection image generating device 10 are attached. As described above, if the back focus deviates from the prescribed distance, prescribed optical characteristics cannot be obtained, as in the occurrence of defocusing, thus degrading the projection image. Therefore, in the manufacturing process, the back focus is adjusted so that the distance between the projection lens unit 31 and the DMD 26 becomes a prescribed distance.

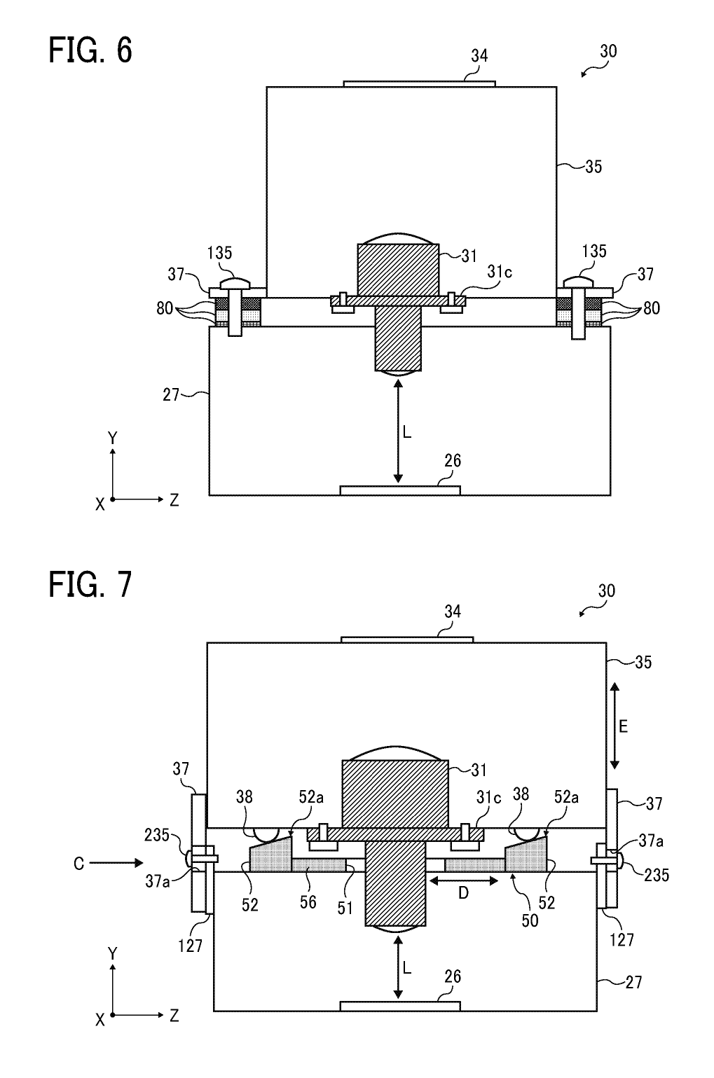

FIG. 6 is a schematic view of a comparative example of the adjustment of the back focus. In the comparative example, the back focus L (the distance between the projection lens unit 31 and the DMD 26 L) is adjusted by attaching the projection housing 35 to the lighting housing 27 with an adjustment shim 80 interposed between an attachment portion 37 of the projection housing 35 and the lighting housing 27. Therefore, in the comparative example, the following adjustment work is performed. That is, when the prescribed optical characteristics, such as focus, are not obtained, the projection optical device 30 is removed from the lighting housing 27 and the single adjustment shim 80 is interposed between the attachment portion 37 of the projection housing 35 and the lighting housing 27 and the projection optical device 30 is attached to the lighting housing 27. Then, it is checked whether the prescribed optical characteristics are obtained. If the prescribed optical characteristics are not obtained, the projection optical device 30 is removed from the lighting housing 27 again. Next, the number of adjustment shims 80 interposed between the attachment portion 37 and the lighting housing 27 is changed, and the projection housing 35 is attached to the lighting housing 27 again. Then, the optical characteristics are checked again. By repeating such operations, the distance L between the projection lens unit 31 and the DMD 26 is set to a predetermined distance. Therefore, in the comparative example, the adjustment work and the lead time of the manufacturing process is likely to be long, which may cause an increase in manufacturing cost.

In addition, it is necessary to prepare a plurality of adjustment shims 80 having different thicknesses, which causes an increase in cost due to an increase in the number of parts. Further, the plurality of adjusting shims 80 having different thicknesses includes an adjustment shim 80 of a frequently-used thickness and an adjustment shim 80 of a less-frequently-used thickness, thus causing deviation of usage amount. Accordingly, it may become difficult to manage parts inventory at the time of mass production of products.

Hence, in the present embodiment, the projection housing 35 is supported so as to be movable in the vertical direction. The back focus is adjusted by moving the projection housing 35 in the vertical direction while confirming whether the prescribed optical characteristic are obtained. Below, the above-described configuration is further described with reference to the drawings.

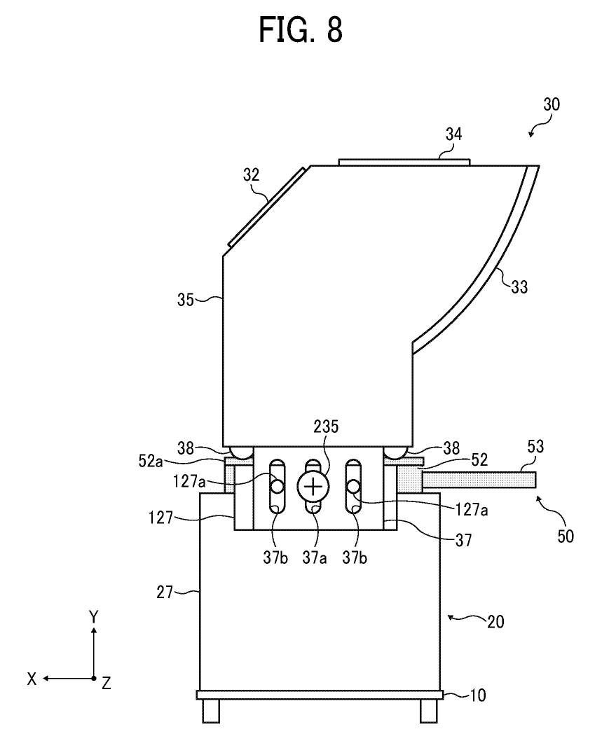

FIG. 7 is a schematic cross-sectional view of the projection optical device 30, the lighting housing 27, and the DMD 26 in the present embodiment. FIG. 8 is a schematic side view seen from a direction indicated by arrow C in FIG. 7. The projection lens unit 31 is provided with a flange portion 31c. The projection lens unit 31 is attached to the projection housing 35 by attaching the flange portion 31c to a lower surface of the projection housing 35 with screws.

A slider 50 as a mover to move the projection housing 35 in the vertical direction (Y direction) is disposed between the lighting housing 27 and the projection housing 35. The vertical direction is an incident direction in which the projection image is incident on the projection lens 31a. The slider 50 includes a base portion 56 and mount portions 52. The base portion 56 has a through hole 51 through which the projection lens unit 31 passes. The mount portions 52 are disposed at both ends of the slider 50 in the Z direction, to support the projection housing 35. The through hole 51 of the base portion 56 has an elongated hole shape extending long in the Z direction. The length of the through hole 51 in the X direction is substantially the same as the diameter of a penetrating portion of the projection lens unit 31 that penetrates the through hole 51. A contact surface of the slider 50 to contact the upper surface of the lighting housing 27 is parallel to the upper surface of the lighting housing 27 and is slidable on the upper surface of the lighting housing 27 without being caught on the upper surface of the lighting housing 27. Accordingly, the slider 50 is slidable in a predetermined range in the Z direction as indicated by arrow D in FIG. 7 and is held immovable in the X direction.

A plurality of hemispherical legs 38 are disposed on the lower surface of the projection housing 35. The legs 38 may be provided so as to be supported by the mount portions 52 of the slider 50 without rattling. In the present embodiment, the four legs 38 are arranged at equal intervals so as to surround the projection lens unit 31, and the projection housing 35 is supported at four points on the mount portions 52. Note that the number of legs 38 is not limited to four but, for example, the three legs 38 may be supported at three points on the mount portions 52.

A contact surface 52a of the mount portion 52 to contact the leg 38 is an inclined surface that gradually decreases in height from in an end portion on the +Z direction side (the right-side in FIG. 7) toward the −Z direction (the left side in FIG. 7). The mount portion 52 extends in the X direction. The mount portion 52 on the left side in FIG. 7 supports two legs 38 that are disposed on the left side in FIG. 7 away from each other at a predetermined interval in the X direction. The mount portion 52 on the right side in FIG. 7 supports two legs 38 that are disposed on the right side in FIG. 7 away from each other at a predetermined interval in the X direction. In the present embodiment, two legs 38 are supported by one mount portion 52. However, in some embodiments, the mount portion 52 may be disposed corresponding to each leg 38.

The attachment portions 37 to be attached to attached portions 127 of the lighting housing 27 are disposed on both side surfaces of the projection housing 35 in the Z direction. Unlike the comparative example of FIG. 6, the attachment portions 37 are disposed perpendicular to the Z direction. As illustrated in FIG. 8, a long screw through hole 37a is disposed in the middle of each attachment portion 37 in the X direction. The screw through hole 37a is long in the vertical direction (Y direction). A locking screw 235 as a lock to regulate the vertical movement of the projection housing 35 passes through the screw through hole 37a. The attachment portion 37 has guide holes 37b extending in the vertical direction (Y direction) on both sides of the screw through hole 37a in the X direction. Guide pins 127a of the attached portions 127 pass through the guide holes 37b. As illustrated in FIG. 8, an operation lever 53 is disposed at an end portion of the slider 50 in the −X direction.

Adjustment of the back focus (the distance L between the projection lens unit 31 and the DMD 26) in the present embodiment is performed as follows. First, the locking screws 235 are loosened to make the projection housing 35 movable in the vertical direction. Next, optical characteristics, such as focus, is checked by, for example, projecting an inspection image on the projection surface 101. When the prescribed optical characteristics are not obtained, the operation lever 53 is operated to slide and move the slider 50 in the D direction of FIG. 7. By sliding the slider 50 in the D direction of FIG. 7, each leg 38 relatively moves the inclined contact surface 52a, and the projection housing 35 moves in the vertical direction (Y direction) as indicated by arrow E in FIG. 7. Accordingly, the projection lens unit 31 held on the projection housing 35 moves with the projection housing 35 in the vertical direction. Thus, the back focus (the distance L between the projection lens unit 31 and the DMD 26) is adjusted. For example, when the slider 50 is slid in the −Z direction (to the left side in FIG. 7), each leg 38 relatively climbs the inclined contact surface 52a, and the projection housing 35 ascends. Accordingly, the projection lens unit 31 held on the projection housing 35 ascends with the projection housing 35, thus increasing the distance L between the projection lens unit 31 and the DMD 26. By contrast, when the slider 50 is slid in the +Z direction (to the right side in FIG. 7), each leg 38 relatively descends the inclined contact surface 52a, and the projection housing 35 descends. Accordingly, the projection lens unit 31 held on the projection housing 35 descends with the projection housing 35, thus reducing the distance L between the projection lens unit 31 and the DMD 26.

As illustrated in FIG. 8, the projection housing 35 may be movable only in the vertical direction by a guide assembly including the guide pins 127a and the guide holes 37b. For such a configuration, sliding the slider 50 can prevent the projection housing 35 from moving in the X direction and the Z direction with respect to the lighting housing 27 during the back focus adjustment.

When the distance L between the projection lens unit 31 and the DMD 26 is adjusted to a prescribed distance and the prescribed optical characteristics are obtained, the locking screws 235 are tightened to lock the movement of the projection housing 35 in the Z direction. Thus, the distance L between the projection lens unit 31 and the DMD 26 is maintained in an appropriate relationship.

As described above, in the present embodiment, the back focus can be adjusted while viewing the inspection image projected on the projection surface 101. Such a configuration facilitates the back focus adjustment as compared with the comparative example in which the back focus is adjusted by changing the combination of adjustment shims and confirming whether the optical characteristics are optimum plural times. Further, the distance L between the projection lens unit 31 and the DMD 26 can be adjusted to an appropriate relationship without removing the projection optical device 30 from the lighting housing 27. Accordingly, in the present embodiment, the back focus adjustment can be more easily and quickly performed than the comparative example in which the adjustment shim 80 is interposed between the lighting housing 27 and the projection lens unit 31 to adjust the distance between the projection lens unit 31 and the DMD 26 to a prescribed relationship. Accordingly, the adjustment work can be shortened as compared with the comparative example and the lead time of the manufacturing process can be shortened, thus suppressing an increase in the manufacturing cost. Even if there are some manufacturing errors or the like, good optical characteristics can be obtained by sliding the slider 50. There is also a merit that it is not necessary to extremely precisely manufacture components, such as the lighting housing and the projection housing.

In addition, it is not necessary to prepare a plurality of adjustment shims 80 having different thicknesses, thus suppressing an increase in cost due to an increase in the number of parts. In addition, since it is not necessary to use the adjustment shim 80, there is also an advantage that the management of parts inventory at the time of mass production of products becomes easy.

In the present embodiment, the projection housing 35 holding the projection lens unit 31, the reflection mirror 32, and the curved mirror 33 is moved in the vertical direction to adjust the distance L (back focus) between the projection lens unit 31 and the DMD 26. Accordingly, the distance relationship between the projection lens unit 31 and the reflection mirror 32 or the curved mirror 33 does not vary even after the back focus adjustment. As a result, such a configuration can prevent occurrence of defects in the projection image due to variations in the positional relationship between the projection lens unit 31 and the reflection mirror 32 or the curved mirror 33 after the adjustment.

In the present embodiment, the projection housing 35 can be moved in the vertical direction by a single operation of moving the slider 50 in the Z direction. Thus, the back focus can be adjusted with a simple operation. Since the projection housing 35 can be continuously moved in the vertical direction by a single operation of moving the slider 50 in the Z direction, fine adjustment can be performed to adjust the back focus with higher precision, thus enhancing the quality of the projection image.

It is also preferable to reduce the angle of inclination of the contact surface 52a. By reducing the angle of inclination of the contact surface 52a, the amount of movement of the projection housing 35 in the vertical direction can be reduced relative to the movement amount of the slider 50 in the Z direction. Thus, there is an advantage that fine adjustment of the back focus can be easily performed.

In the above description, the slider 50 is part of the projection optical device 30. In some embodiments, the slider 50 may be removably attachable to the projection optical device and used in a production process as an adjustment jig that is attached to the projection optical device in the back focus adjustment.

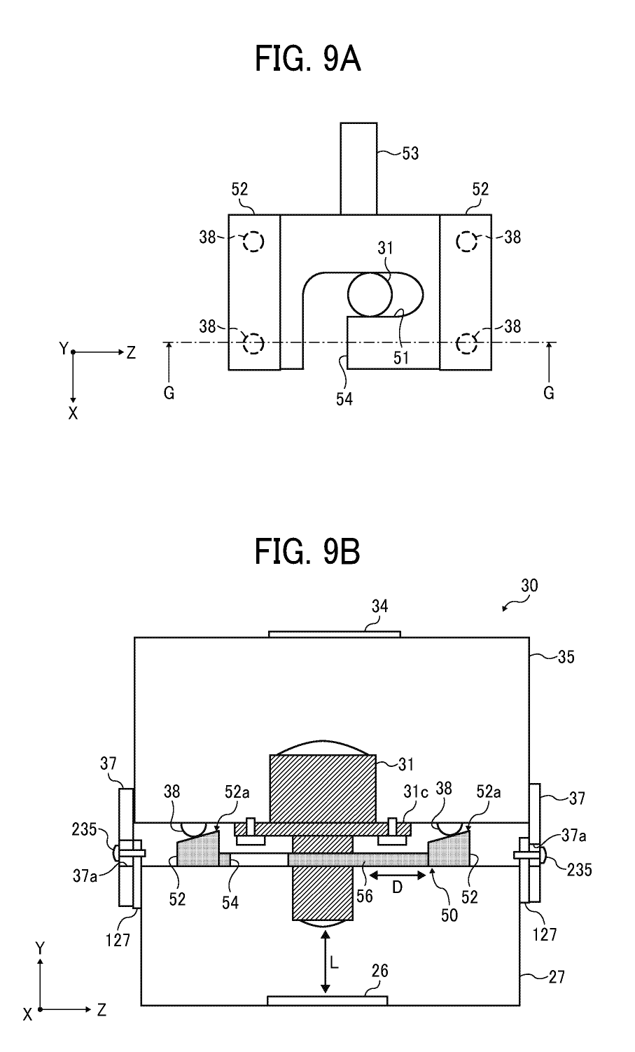

FIGS. 9A and 9B are illustrations of an example of the slider 50 that is an adjuster used as an adjustment jig in the production process. FIG. 9A is a schematic plan view of the slider 50. FIG. 9B is a schematic cross-sectional view of the projection optical device 30 cut in a G-G direction in FIG. 9A. The slider 50 has a cutout 54 at an end portion of the through hole 51 in the −Z direction (on the left side in FIG. 9B). The penetrating portion of the projection lens unit 31 to penetrate the through hole 51 passes through the cutout 54. The cutout 54 is disposed on the side (the −Z direction side) corresponding to the lower side of the contact surface 52a in the direction of inclination of the contact surface 52a.

At the time of back focus adjustment, first, the slider 50 is inserted between the lighting housing 27 and the projection housing 35 while inserting the penetrating portion of the projection lens unit 31, which penetrates the through hole 51, into the cutout 54. Next, when the slider 50 is inserted until the penetrating portion of the projection lens unit 31, which penetrates the through hole 51, is positioned in the through hole 51, the slider 50 is slid in the −Z direction (the left side in FIG. 9B) to contact the legs 38 of the projection housing 35 with the contact surfaces 52a. Then, the locking screws 235 are loosened so that the projection housing 35 can be moved in the vertical direction, and the distance L (back focus) between the projection lens unit 31 and the DMD 26 is adjusted in the same manner as described above. After the back focus adjustment, the locking screws 235 are tightened to lock the vertical position of the projection housing 35, and then the slider 50 is slid to the +Z direction (the right side in FIG. 9B). The inclination of the contact surface 52a of the slider 50 is an inclination that descends in the −Z direction (the left side in FIG. 9B). Accordingly, the movement of the slider 50 in the −Z direction (the left side in FIG. 9B) is restricted by the legs 38 and cannot be moved. By contrast, the slider 50 can also move in the +Z direction (the right side in FIG. 9B) after the lock. Thus, the cutout 54 at the end portion of the through hole 51 on the −Z direction side allows the slider 50 from being removed from the device body after locking. For example, the slider 50 is moved in the +Z direction (the right side in FIG. 9B) so that the penetrating portion of the projection lens unit 31, which penetrates the through hole 51, is positioned at the end portion of the through hole 51 on the −Z direction side, which communicates with the cutout 54. Then, the slider 50 is moved in the −X direction (the upper side in FIG. 9A) and is pulled out from between the lighting housing 27 and the projection housing 35. Thus, the slider 50 can be removed from the device body after locking.

As described above, using the slider 50 as an adjustment jig in the production process can obviate the preparation of a plurality of sliders 50 for different devices, thus allowing further cost reduction of the device.

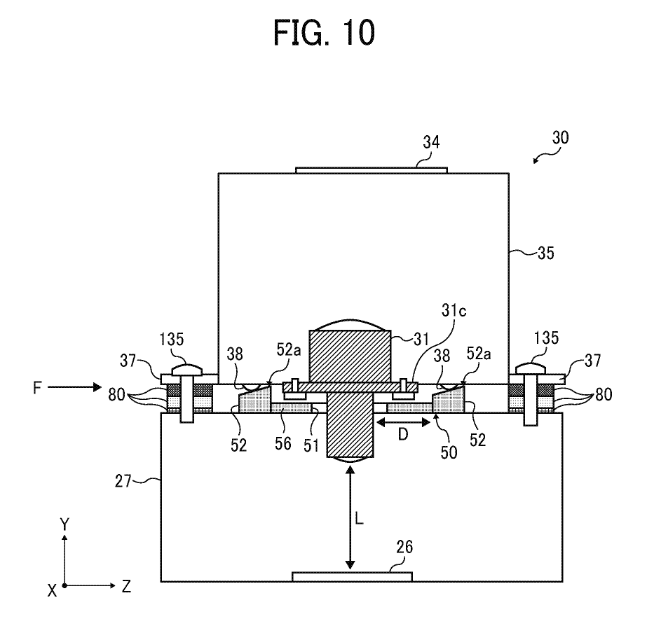

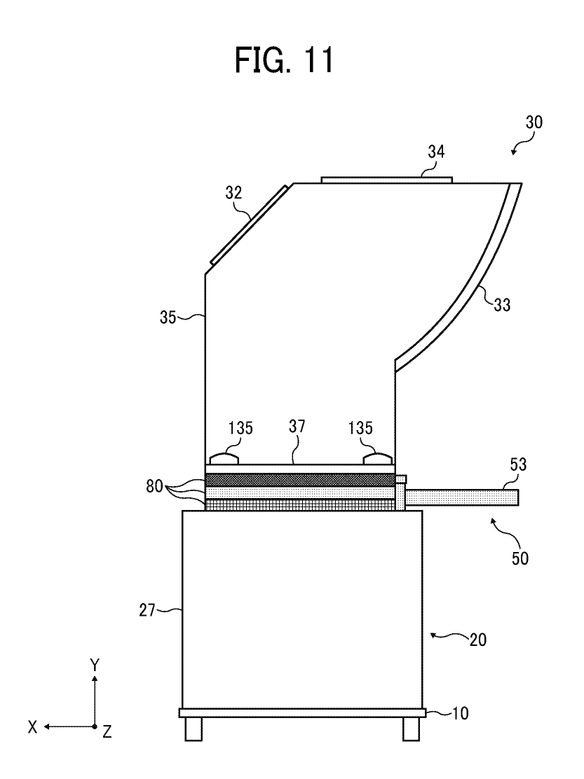

Next, a description is given of variations of the above-described embodiment. FIG. 10 is a cross-sectional view of a part of a variation of the projection optical device according to the above-described embodiment. FIG. 11 is a side view of the variation seen from a direction indicated by arrow F in FIG. 10. In the present variation, after the distance L (back focus) between the projection lens unit 31 and the DMD 26 is adjusted with the slider 50, the projection housing 35 is attached to the lighting housing 27 with the adjustment shims 80 being interposed between the lighting housing 27 and the attachment portion 37. The attachment portion 37 is disposed perpendicular to the vertical direction of the projection housing 35.

In the present variation, after the distance L (back focus) between the projection lens unit 31 and the DMD 26 is adjusted to an appropriate relationship using the slider 50, a gap between the attachment portion 37 and the lighting housing 27 is measured with a measuring device. As the measuring device, for example, a laser displacement meter can be used. In some embodiments, the gap between the attachment portion 37 and the lighting housing 27 may be captured with a camera and measured based on the captured image data. Next, based on the measured gap, the adjustment shims 80 are combined so as to have the same length as the length of the measured gap in the thickness direction. After removing the projection optical device 30 from the lighting housing 27, the combined set of adjustment shims 80 is interposed between the attachment portion 37 and the lighting housing 27. Then, the projection housing 35 is attached to the lighting housing 27 with attachment screws 135.

In the present variation, a proper combination of the adjustment shims 80 can be easily found that can make the distance L (back focus) between the projection lens unit 31 and the DMD 26 in an appropriate relationship. Such a configuration can more easily perform back focus adjustment than the comparative example in which a proper combination of the adjustment shims 80, which can set the distance L (back focus) between the projection lens unit 31 and the DMD 26 in an appropriate relationship, can be found by changing the combination of the adjustment shims and repeatedly confirming whether the optical characteristics are optimum.

In the present variation, the slider 50 may also be part of the projection optical device 30. In some embodiments, as illustrated in FIGS. 9A and 9B, the slider 50 may also be removably attachable to the projection optical device 30 and used in a production process as an adjustment jig that is attached to the projection optical device 30 in the back focus adjustment.

Alternatively, in some embodiments, the lighting housing 27 may be movable in the vertical direction while the projection housing 35 is stationary, and the back focus may be adjusted by moving the lighting housing 27 in the vertical direction with the slider 50.

The above-described embodiments and variations are only examples and, for example, the following aspects of the present disclosure can give advantages described below.

Aspect 1

A projection optical device, such as the projection optical device 30, includes a projection lens unit, such as the projection lens unit 31, holding a projection lens, such as the plurality of projection lenses 31a, on which a projection image generated by an image generating device, such as the DMD 26, is incident; a projection optical element, such as the reflection mirror 32 and the curved mirror 33, to guide the projection image, which has passed through the projection lens, to a projection surface, such as the projection surface 101; an optical housing, such as the lighting housing 27, attached with the image generating device; a holder, such as the projection housing 35, attached to the optical housing, the holder holding the projection lens unit and the projection optical element; and a mover, such as the slider 50, to relatively move the holder with respect to the optical housing in an incident direction in which the projection image is incident on the projection lens. According to the aspect 1, as described in the above-described embodiment, the mover, such as the slider 50, moves the holder, such as the projection housing 35, holding the projection lens unit, such as the projection lens unit 31, relatively with respect to the optical housing, such as the lighting housing 27, to which the image generating device, such as the DMD 26, is attached, in the incident direction in which the projection image is incident on the projection lenses, such as the plurality of projection lenses 31a. Accordingly, the distance between the projection lens unit, such as the projection lens unit 31, and the image generating device, such as the DMD 26, can be adjusted. Thus, the distance between the projection lens unit and the image generating device can be adjusted with the mover so that the prescribed optical characteristics, such as focus, can be obtained. Such a configuration can more simplify the adjustment work than a configuration in which the distance between the projection lens unit, such as the projection lens unit 31, and the image generating device is adjusted by changing the number of adjustment members, such as the adjustment shims 80, interposed between the projection lens unit and the optical housing. Since the holder holds the projection optical element, such as the reflection mirror 32 and the curved mirror 33, the positional relationship between the projection lens unit, such as the projection lens unit 31, and the projection optical element does not change after adjustment. Such a configuration can obviate adjustment of the positional relationship between the projection lens unit, such as the projection lens unit 31, and the projection optical element, such as the reflection mirror 32 and the curved mirror 33, to a prescribed relationship after the adjustment.

Aspect 2

In the aspect 1, the mover, such as the slider 50, continuously moves the holder, such as the projection housing 35, in the incident direction relatively with respect to the optical housing, such as the lighting housing 27, by a single operation. As described in the above-described embodiment, such a configuration can finely adjust the distance, such as the distance L, between the projection lens unit, such as the projection lens unit 31, and the image generating device, such as the DMD 26, by a simple operation.

Aspect 3

In the aspect 2, the mover, such as the slider 50, is disposed between the optical housing, such as the lighting housing 27, and the holder, such as the projection housing 35, and is movable in a direction perpendicular to the incident direction. The holder is configured to move relatively with respect to the optical housing in the incident direction in conjunction with the movement of the mover in the direction perpendicular to the incident direction. In the above-described embodiment, the holder includes a plurality of projections, such as the plurality of legs 38, projecting toward the optical housing side. The mover includes a plurality of contact portions, such as the mount portions 52, to contact the projections from the incident direction. A contact surface of the contact portion is inclined with respect to the direction perpendicular to the incident direction. According to the aspect 3, as described in the embodiment, by moving the mover in the direction perpendicular to the incident direction, the holder, such as the projection housing 35, can be moved relatively with respect to the optical housing, such as the lighting housing 27 in the incident direction.

Aspect 4

In any of the aspects 1 to 3, the projection optical device includes a lock, such as the locking screws 235 to lock the relative movement of the holder, such as the projection housing 35, with respect to the optical housing, such as the lighting housing 27, in the incident direction. According to the aspect 4, as described in the above-described embodiment, after the distance, such as the distance L, between the image generating device, such as the DMD 26, and the projection lens unit, such as the projection lens unit 31, is appropriately adjusted, the relative movement of the holder, such as the projection housing 35, with respect to the optical housing, such as the lighting housing 27, in the incident direction can be prevented, thus suppressing loss of the appropriate distance relationship between the image generating device and the projection lens unit.

Aspect 5

An image projection apparatus, such as the projector 1, includes a light source, such as the light source device 60; the image generating device, such as the DMD 26, to form a projection image with light from the light source; and the projection optical device, such as the projection optical device 30, according to any of the aspects 1 to 4 to project the projection image onto the projection surface, such as the projection surface 101. Such a configuration can suppress an increase in manufacturing cost and project a favorable projection image onto the projection surface.

Aspect 6

An adjuster, such as the slider 50, adjusts a distance between an image generating device, such as the DMD 26, to generate a projection image and a projection lens unit, such as the projection lens unit 31, holding a projection lens, such as the plurality of projection lenses 31a, on which the projection image generated by the image generating device is incident. The adjuster moves a holder, such as the projection housing 35, holding the projection lens unit and a projection optical element, such as the reflection mirror 32 and the curved mirror 33, that guides the projection image having passed through the projection lens 31a to the projection surface, such as the projection surface 101, relatively with respect to the optical housing, such as the lighting housing 27, attached with the image generating device in an incident direction in which the projection image is incident on the projection lens, to adjust the distance between the image generating device and the projection lens unit. In the above-described embodiment, the image generating device, such as the DMD 26, is attached to illumination brackets via the projection image generating device 10 holding the image generating device.

The above-described embodiments are illustrative and do not limit the present disclosure. Thus, numerous additional modifications and variations are possible in light of the above teachings. For example, elements and features of different illustrative embodiments may be combined with each other and substituted for each other within the scope of the present invention.

Any one of the above-described operations may be performed in various other ways, for example, in an order different from the one described above.

What is claimed is:

1. A projection optical device comprising:
a projection lens unit holding a projection lens on which a projection image generated by an image generating device is incident;
a projection optical element to guide the projection image, which has passed through the projection lens, to a projection surface;
an optical housing attached with the image generating device;
a holder attached to the optical housing, the holder holding the projection lens unit and the projection optical element; and
a mover to relatively move the holder with respect to the optical housing in an incident direction in which the projection image is incident on the projection lens.

2. The projection optical device according to claim 1,
wherein the mover continuously moves the holder in the incident direction by a single operation.

3. The projection optical device according to claim 2, wherein the mover is disposed between the optical housing and the holder and movable in a direction perpendicular to the incident direction, and
wherein the holder relatively moves with respect to the optical housing in the incident direction, with movement of the mover in the direction perpendicular to the incident direction.

4. The projection optical device according to claim 1, further comprising a lock to lock relative movement of the holder in the incident direction with respect to the optical housing.

5. An image projection apparatus comprising:
a light source;
the image generating device to form the projection image with light from the light source; and
the projection optical device according to claim 1 to project the projection image onto the projection surface.

6. An adjuster for adjustment of a distance between an image generating device to generate a projection image and a projection lens unit holding a projection lens on which the projection image generated by the image generating device is incident, the adjuster comprising:
a base portion having a through hole through which the projection lens unit passes; and
a plurality of mount portions to support a holder holding the projection lens unit and a projection optical element that guides the projection image, which has passed the projection lens, to a projection surface,
the plurality of mount portions disposed at both ends of the base portion in a direction perpendicular to an incident direction in which the projection image is incident on the projection lens,
each of the plurality of mount portions having a contact surface to contact and relatively move the holder in the incident direction with respect to an optical housing, to which the image generating device is attached, to adjust the distance between the image generating device and the projection lens unit.
